(19) United States
(12) Patent Application Publication
(10) Pub. No.: US 2008/0206645 A1
(43) Pub. Date: Aug. 28, 2008

(54) NON-AQUEOUS ELECTROLYTE SECONDARY BATTERY AND METHOD FOR PRODUCING SAME

(75) Inventor: Masatoshi TAKAHASHI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/038,469

(22) Filed: Feb. 27, 2008

(30) Foreign Application Priority Data
Feb. 27, 2007 (JP) 2007-047228

(51) Int. Cl. H01M 10/04

(52) U.S. Cl. 429/246; 427/58

(57) ABSTRACT

Provided is a non-aqueous electrolyte battery with excellent volume energy density and high safety. The battery includes a positive electrode, a negative electrode, and a non-aqueous electrolyte. Between the positive and negative electrodes is interposed a microporous layer including insulating inorganic particles and a polyolefin. It is preferable that the microporous layer has a thickness of 1 to 10 μm, the polyolefin is polyethylene having a weight-average molecular weight of 500000 or greater, and the insulating inorganic particles have an average particle size of 0.1 to 2 μm.

### BACKGROUND OF THE INVENTION

1. Field of the Invention

The present invention relates to non-aqueous electrolyte secondary batteries with improved volume energy density.

2. Background Art

Non-aqueous electrolyte secondary batteries have been widely used as power supplies for mobile devices because of their high energy density. Such secondary batteries are expected to have further higher volume energy density, as mobile devices including mobile phones and notebook personal computers have been increasingly miniaturized and highly functional in recent years.

A non-aqueous electrolyte secondary battery has a wound electrode assembly which is formed by winding a positive electrode, a negative electrode, and a polyolefin separator interposed therebetween. The separator is required to have the function of providing electrical isolation between the positive and negative electrodes and the function of conducting lithium ions. In terms of safety, the separator is also expected to have the function of stopping the conduction of the lithium ions so as to stop the current (shutdown function) when the battery reaches an abnormally high temperature.

The separator does not contribute to charge-discharge reactions, and therefore a thick separator can decrease the volume energy density of the battery. A thin separator, on the other hand, can be broken when wound or cannot provide electrical isolation between the positive and negative electrodes. As a result, the separator is required to have a thickness of at least 15 to 20 μm.

The techniques to reduce the thickness of the separator are shown in Patent Documents 1 to 3 below in which the separator is a porous film made of insulating material particles bound together by a binder.

Patent Document 1: Japanese Patent Unexamined Publication No. 2006-310302

Patent Document 2: Japanese Patent Unexamined Publication No. H10-241656

Patent Document 3: Japanese Patent Unexamined Publication No. H10-241657

In Patent Document 1, the separator is a porous film made of a ceramic material and an acrylic rubber binder having a three-dimensional cross-linked structure. Patent Document 1 says that the technique provides a battery resistant to short circuits and heat.

In Patent Document 2, the separator is made of insulating material particles bound together by a binder. Patent Document 2 says that the technique provides a battery with excellent rapid discharge characteristics and high volume energy density.

In Patent Document 3, the separator is a layer of insulating material particles bound together by a binder, the insulating material particles having a surface area of 1.0 to 100 m²/g. Patent Document 3 says that the technique provides a battery with excellent charge-discharge cycle characteristics. The problem is, however, that these separators are not safe enough because of the lack of a shutdown function.

### SUMMARY OF THE INVENTION

In order to solve the above-mentioned problem, the present invention has an object of providing a non-aqueous electrolyte secondary battery with high volume energy density and high safety.

(1) To solve the above-mentioned problem, the non-aqueous electrolyte battery of the present invention includes:

a positive electrode;

a negative electrode; and

a non-aqueous electrolyte, wherein

a microporous layer including insulating inorganic particles and a polyolefin is formed between the positive electrode and the negative electrode.

This structure has the following advantages. The microporous layer containing the insulating inorganic particles and the polyolefin provides electrical isolation between the positive and negative electrodes, and the gaps between the inorganic particles pass lithium ions smoothly. In addition, when the battery reaches an abnormally high temperature, the polyolefin melts and closes the gaps between the inorganic particles so as to shutdown the flow of the lithium ions, ensuring the safety of the battery. Furthermore, the microporous layer, which can be thinner than the conventional separator, allows the battery to have higher volume energy density. Note that the microporous layer needs to be formed only in a portion where the positive and negative electrodes are opposed to each other.

In the above-described structure, the polyolefin may be polyethylene having a weight-average molecular weight of 500000 or greater.

The polyolefin can be polypropylene, polyethylene, or the like, but polyethylene is better in terms of safety than polypropylene because of having a lower shutdown temperature than polypropylene by 15 to 20° C. The reason the preferable weight-average molecular weight of polyethylene is 500000 or greater is that when the weight is considerably smaller than that, the shutdown function becomes insufficient.

In the above-described structure, the microporous layer may have a thickness of 1 to 10 μm.

The microporous layer is required to have (i) the function of providing electrical isolation between the positive and negative electrodes, (ii) the function of passing lithium ions smoothly, and (iii) the function of shutting down the battery if it reaches an abnormally high temperature. To perform these functions, the microporous layer needs to have a thickness of at least 1 μm. However, a microporous layer having too large a thickness causes a decrease in volume energy density. Therefore, the thickness is preferably 10 μm or less, and more preferably 2 to 7.5 μm.

In the above-described structure, the insulating inorganic particles may have an average particle size of 0.1 to 2 μm.

This range is preferable because of the following reason. Insulating inorganic particles having too large an average particle size make it difficult to reduce the thickness of the microporous layer. On the other hand, insulating inorganic particles having too small an average particle size narrow the insulating gaps between the inorganic particles, thereby preventing the conduction of the lithium ions. The average particle size is more preferably 0.2 to 1 μm.

In the above-described structure, the insulating inorganic particles may be at least one selected from the group consisting of aluminum oxide particles, titanium oxide particles, and magnesium oxide particles.

These particles are preferable because of having the properties required to the insulating inorganic particles, that is, the property of forming gaps therebetween to allow lithium ions to pass through and the property of not hindering charge-discharge reactions. Preferably, the insulating inorganic particles having such properties include aluminum oxide particles, titanium oxide particles, and magnesium oxide particles.

In the above-described structure, the insulating inorganic particles and the polyolefin are mixed in the microporous layer, wherein the polyolefin content of the microporous layer may be 3 to 20% by mass.

This range is preferable because of the following reason. When the polyolefin content of the microporous layer is too small, the shutdown function may become insufficient. When the polyolefin content is too large, on the other hand, the polyolefin fills the gaps between the insulating inorganic particles so as to block the flow of the lithium ions, thereby preventing the conduction of the lithium ions. The polyolefin content of the microporous layer is more preferably 5 to 15% by mass. The polyolefin may be in granular form, and the primary particle preferably has an average particle size of 0.1 to 5 μm.

(2) The non-aqueous electrolyte battery is produced by the method including:

a coating step for applying a slurry to a surface of at least one of a positive electrode and a negative electrode, the slurry containing insulating inorganic particles, polyolefin, a binder, and a solvent;

a microporous layer formation step for volatizing the solvent so as to form a microporous layer on the surface of the at least one of the positive electrode and the negative electrode after the coating step, the microporous layer containing the insulating inorganic particles and the polyolefin, and

an electrode sandwiching step for sandwiching the positive electrode and the negative electrode with the microporous layer interposed therebetween.

This structure allows the efficient production of a microporous layer which provides electrical isolation between the positive and negative electrodes, conducts lithium ions, and shuts down the battery when it reaches an abnormally high temperature.

In the above-described method for producing a non-aqueous electrolyte secondary battery, the polyolefin may be polyethylene having a weight-average molecular weight of 500000 or greater.

The microporous layer may have a thickness of 1 to 10 μm.

The insulating inorganic particles may have an average particle size of 0.1 to 2 μm.

The insulating inorganic particles may be at least one selected from the group consisting of aluminum oxide particles, titanium oxide particles, and magnesium oxide particles.

The polyolefin content of the microporous layer may be 3 to 20% by mass.

As described hereinbefore, the present invention provides a battery with excellent volume energy density and high safety.

### DESCRIPTION OF THE INVENTION

The present invention is described in detail as follows in examples. Note that the present invention is not limited to the following examples and can be modified without departing from the scope of the invention.

### EXAMPLE 1

### Production of Positive Electrode

A positive electrode was produced as follows. First, a positive electrode active material slurry was made by mixing 95 parts by mass of lithium cobalt oxide (LiCoO₂), 2 parts by mass of graphite powder as a conductive agent, 3 parts by mass of polyvinylidene fluoride (PVdF) as a binder, and N-methyl-2-pyrrolidone (NMP). Then, the positive electrode active material slurry was applied to both sides of an aluminum positive electrode current collector, dried, and rolled.

### Production of Negative Electrode

A negative electrode was produced as follows. First, a negative electrode active material slurry was made by mixing 98 parts by mass of graphite as a negative electrode active material, 1 part by mass of styrene-butadiene rubber as a binder, 1 part by mass of carboxymethylcellulose as a thickener, and water. Then, the negative electrode active material slurry was applied to both sides of a copper negative electrode current collector, dried and rolled.

### Formation Step (1) of Microporous Layer: Coating Process

A slurry was made by mixing 85 parts by mass of aluminum oxide (Al₂O₃) having an average particle size of 0.3 μm, 10 parts by mass of polyethylene resin having a weight-average molecular weight of 500000 and an average primary particle size of 2 μm, and 5 parts by mass of an acrylic rubber binder. The slurry was dispersed into N-methyl-2-pyrrolidone (NMP) as a solvent, and applied to both sides of the negative electrode.

### Formation Step (2) of Microporous Layer: Drying Process

Later, the solvent (NMP), which is necessary to prepare the slurry was dried so as to form a 5 μm-thick microporous layer on both sides of the negative electrode.

### Production of Electrode Assembly

A flat wound electrode assembly was produced by winding the positive electrode and the negative electrode and pressing it.

### Preparation of Non-Aqueous Electrolyte

A non-aqueous electrolyte was prepared as follows. First, ethylene carbonate (EC) and ethyl methyl carbonate (EMC) as a non-aqueous solvent were mixed in a volume ratio of 30:70 at 25° C. Then, LiPF₆ as electrolyte salt was dissolved therein in such a manner as to be 1 M (moles/liter).

Battery Assembly

The flat wound electrode assembly was inserted into an outer can and filled with an electrolytic solution. The opening of the outer can was sealed. As a result, the non-aqueous electrolyte secondary battery of Example 1 having a thickness of 5.5 mm, a width of 34 mm, and a height of 50 mm was produced.

### EXAMPLE 2

A non-aqueous electrolyte secondary battery of Example 2 was produced in the same manner as in Example 1 except for having used polyethylene resin whose weight-average molecular weight is 1000000.

### EXAMPLE 3

A non-aqueous electrolyte secondary battery of Example 3 was produced in the same manner as in Example 1 except for having used polyethylene resin whose weight-average molecular weight is 300000.

### COMPARATIVE EXAMPLE 1

A non-aqueous electrolyte secondary battery of Comparative Example 1 was produced in the same manner as in Example 1 except that the slurry used in the formation of the microporous layer was made by dispersing 95 parts by mass of Al₂O₃ and 5 parts by mass of an acrylic rubber binder into a solvent (NMP).

### COMPARATIVE EXAMPLE 2

A non-aqueous electrolyte secondary battery of Comparative Example 2 was produced in the same manner as in Example 1 except that the slurry used in the formation of the microporous layer was made by dispersing 95 parts by mass of polyethylene resin and 5 parts by mass of an acrylic rubber binder into a solvent (NMP).

### COMPARATIVE EXAMPLE 3

A non-aqueous electrolyte secondary battery of Comparative Example 3 was produced in the same manner as in Example 1 except for having used a separator made of 20 μm thick polyethylene, without forming a microporous layer on the surface of the negative electrode.

### Battery Characteristics Test

Ten batteries were used for each of the Examples and the Comparative Examples to test their initial capacity, charge-discharge cycle characteristics, and safety under the following conditions. The results are shown in Table 1 below.

### Initial Capacity Test

Charging conditions: Charging was performed at a constant current of 1000 mA at 25° C. until the voltage reached 4.2V, and then performed at a constant voltage of 4.2V at 25° C. until the current reached 50 mA.

Discharging conditions: Discharging was performed at a constant current of 200 mA at 25° C. until the voltage reached 2.75V.

### Charge-Discharge Cycle Characteristics Test

(1) Charging was performed at a constant current of 1000 mA at 25° C. until the voltage reached 4.2V and then performed at a constant voltage of 4.2V until the current reached 50 mA

(2) Having a rest period of 10 minutes

(3) Discharging was performed at a constant current of 1000 mA at 25° C. until the voltage reached 2.75V

(4) Having a rest period of 10 minutes

(5) Returning to (1)

Note that charge-discharge cycle characteristics (%)=discharge capacity of the 500th cycle÷discharge capacity of the first cycle×100

### Safety Test

Charging was performed at a constant current of 1000 mA at 25° C. until the voltage reached 4.2V, and then performed at a constant voltage of 4.2V until the current reached 50 mA.

When in a charged condition, the batteries were subjected to an external short-circuit in the constant temperature chamber of 60° C. and kept for a while to check whether smoke or ignition was caused (NG) or not caused (OK).

TABLE 1

| | initial | charge-discharge cycle | |
|---|---|---|---|
| | capacity | characteristics | |
| | (mAh) | (%) | safety test |
| Example 1 | 1000 | 85 | 10/10 OK |
| Example 2 | 1000 | 85 | 10/10 OK |
| Example 3 | 1000 | 85 | 5/10 OK |
| Comparative | 1000 | 85 | 10/10 NG |
| Example 1 | | | |
| Comparative | discharge | charge-discharge was | — |
| Example 2 | was | impossible | |
| | impossible | | |
| Comparative | 920 | 85 | 10/10 OK |
| Example 3 | | | |

Table 1 indicates the following. Discharge is impossible in Comparative Example 2 where the layer is made of polyethylene resin and a binder. The batteries of Examples 1 to 3 show excellent charge-discharge cycle performance with charge-discharge cycle characteristics of 85%.

These results are considered to be due to the following reasons. Comparative Example 2 cannot perform charge-discharge cycles because the layer made of polyethylene and a binder does not have micropores to conduct lithium ions. On the other hand, Examples 1 to 3 have high charge-discharge cycle characteristics because the layer made of insulating inorganic particles (Al₂O₃), polyethylene, and a binder has a large number of micropores in the insulating gaps between the inorganic particles so as to conduct lithium ions.

Table 1 also indicates that Comparative Example 3 using a conventional separator has an initial capacity of 920 mAh, which is far lower than 1000 mAh of Examples 1 to 3.

The reason for this is considered as follows. The microporous layer of the present invention is 5 μm thick, which is smaller than the separator (20 μm thick) of Comparative Example 3. This small thickness allows Examples 1 to 3 to pack a larger amount of active material in the outer can than Comparative Example 3, thereby increasing the initial discharge capacity.

Table 1 also indicates that Comparative Example 1 in which the layer is made of insulating inorganic particles and a binder had a safety test result of 10/10 NG, which is inferior to 10/10 OK to 5/10 OK (0/10 NG to 5/10 NG) of Examples 1 to 3 in which the layer is made of insulating inorganic particles, polyethylene, and a binder.

The reason for this is considered as follows. The layer made of insulating inorganic particles and a binder has low safety at an external short-circuit because of not having a shutdown function. On the other hand, the layer made of insulating inorganic particles, polyethylene, and a binder has high safety because when the battery reaches an abnormally high temperature, polyethylene of the layer closes the gaps between insulating inorganic particles, so that the current can be shut down before the battery emits smoke.

Table 1 also indicates that Example 3 using polyethylene whose weight-average molecular weight is 300000 has a safety test result of 5/10 NG, which is inferior to 10/10 OK of Examples 1 and 2 using polyethylene whose weight-average molecular weight is 500000 or greater.

The reason for this is considered as follows. Polyethylene having too small a weight-average molecular weight prevents the shutdown function from being well performed, possibly causing smoke. This is the reason that the preferable weight-average molecular weight of polyethylene is 500000 or greater.

### Addition

In examples 1 to 3, the insulating inorganic particles are aluminum oxide (Al₂O₃), but can alternatively be titanium oxide, magnesium oxide, or the mixture thereof.

In examples 1 to 3, the microporous layer is formed on the surface of the negative electrode, but can alternatively be formed on the surface of the positive electrode.

### INDUSTRIAL APPLICABILITY

As described hereinbefore, the present invention provides a non-aqueous electrolyte secondary battery with excellent volume energy density and high safety, which is industrially useful.

What is claimed is:

1. A non-aqueous electrolyte secondary battery comprising:
a positive electrode;
a negative electrode; and
a non-aqueous electrolyte, wherein
a microporous layer including insulating inorganic particles and a polyolefin is formed between the positive electrode and the negative electrode.

2. The non-aqueous electrolyte secondary battery of claim 1, wherein
the polyolefin is polyethylene having a weight-average molecular weight of not less than 500000.

3. The non-aqueous electrolyte secondary battery of claim 2, wherein
the microporous layer has a thickness of 1 to 10 μm.

4. The non-aqueous electrolyte secondary battery of claim 3, wherein
the insulating inorganic particles have an average particle size of 0.1 to 2 μm.

5. The non-aqueous electrolyte secondary battery of claim 4, wherein
the insulating inorganic particles are at least one kind selected from a group consisting of aluminum oxide particles, titanium oxide particles, and magnesium oxide particles.

6. The non-aqueous electrolyte secondary battery of claim 5, wherein
the microporous layer is characterized by the mixture of the insulating inorganic particles and the polyolefin.

7. The non-aqueous electrolyte secondary battery of claim 6, wherein
a polyolefin content of the microporous layer is 3 to 20% by mass.

8. The non-aqueous electrolyte secondary battery of claim 1, wherein
the microporous layer has a thickness of 1 to 10 μm.

9. The non-aqueous electrolyte secondary battery of claim 1, wherein
the insulating inorganic particles have an average particle size of 0.1 to 2 μm.

10. The non-aqueous electrolyte secondary battery of claim 1, wherein
the insulating inorganic particles are selected from a group consisting of aluminum oxide particles, titanium oxide particles, and magnesium oxide particles.

11. The non-aqueous electrolyte secondary battery of claim 1, wherein
the microporous layer is characterized by the mixture of the insulating inorganic particles and the polyolefin.

12. The non-aqueous electrolyte secondary battery of claim 1, wherein
a polyolefin content of the microporous layer is 3 to 20% by mass.

13. A method for producing a non-aqueous electrolyte secondary battery, the method comprising:
a coating step for applying a slurry to a surface of at least one of a positive electrode and a negative electrode, the slurry containing insulating inorganic particles, polyolefin, a binder, and a solvent;
a microporous layer formation step for volatizing the solvent so as to form a microporous layer on the surface of the at least one of the positive electrode and the negative electrode after the coating step, the microporous layer containing the insulating inorganic particles and the polyolefin, and
an electrode sandwiching step for sandwiching the positive electrode and the negative electrode with the microporous layer interposed therebetween.

14. The method of claim 13, wherein
the polyolefin is a polyethylene having a weight-average molecular weight of not less than 500000.

15. The non-aqueous electrolyte secondary battery of claim 14, wherein
the microporous layer has a thickness of 1 to 10 μm.

16. The method of claim 15, wherein
the insulating inorganic particles have an average particle size of 0.1 to 2 μm.

17. The method of claim 16, wherein
the insulating inorganic particles are at least one kind selected from a group consisting of aluminum oxide particles, titanium oxide particles, and magnesium oxide particles.

18. The method of claim 17, wherein
a polyolefin content of the microporous layer is 3 to 20% by mass.
